(19) United States
(12) Patent Application Publication
(10) Pub. No.: US 2016/0237978 A1
(43) Pub. Date: Aug. 18, 2016

(54) Gear Pump for Hydroelectric Power Generation

(71) Applicant: EATON CORPORATION, Cleveland, OH (US)

(72) Inventors: Swaminathan Subramanian, Farmington Hills, MI (US); Matthew Gareld Swartzlander, Battle Creek, MI (US)

(73) Assignee: Eaton Corporation, Cleveland, OH (US)

(21) Appl. No.: 15/025,489

(22) PCT Filed: Sep. 30, 2014
(86) PCT No.: PCT/US2014/058212

§ 371 Date: Mar. 28, 2016

Related U.S. Application Data
(60) Provisional application No. 61/884,636, filed on Sep. 30, 2013.
(60) Provisional application No. 61/991,371, filed on May 9, 2014.

(51) Int. Cl. F03B 13/06; F03B 13/08; F04C 15/00; F04C 15/06; F04C 14/04; F04C 2/16

(52) U.S. Cl. CPC F03B 13/06; F04C 14/04; F04C 2/16; F04C 15/0061; F04C 15/06; F03B 13/08; F04C 2240/30; F04C 2240/60; F04C 2240/20

(57) ABSTRACT

A gear pump unit for hydroelectric power generation comprises a generator (138) and a control module operatively connected to a gear pump (131). The gear pump (131) comprises a case (131B) with a fluid inlet (132) and an outlet (135). A first rotor (133) comprises a first plurality of radially spaced teeth (133A, 133B, 133C) that wrap around the first rotor helically in a clockwise direction. A second rotor (134) comprises a second plurality of radially spaced teeth (134A, 134B, 134C) that wrap around the second rotor helically in a counter-clockwise direction. The first plurality of teeth mesh with the second plurality of teeth. The gear pump unit operates in a pump, turbine, or siphon mode via the control module 150 selectively rotating the first and second rotors. Electricity is generated by coupling the rotational energy of the first and second rotors to the generator (138).

### TECHNICAL FIELD

The present disclosure relates generally to a gear pump unit for generating hydroelectric power. More specifically, the bidirectional gear pump unit utilizes a modified supercharger to generate electricity.

### BACKGROUND

By applying the simple concept of using water to turn a turbine that in turn turns a metal shaft in an electric generator, a hydroelectric power generator harnesses energy to generate electricity. The turbine is an important component of the hydroelectric power generator. A turbine is a device that uses flowing fluids to produce electrical energy. One of the parts is a runner, which is the rotating part of the turbine that converts the energy of falling water into mechanical energy.

There are two main types of hydro turbines, impulse and reaction. Impulse turbines use the velocity of the water to move the runner and discharges the water at atmospheric pressure. There is no suction on the down side of the turbine, and the water flows out the bottom of the turbine housing after hitting the runner. An impulse turbine is generally suitable for high head applications.

Reaction turbines develop power from the combined action of pressure and moving water. The runner is placed directly in a water stream flowing over the blades. Reaction turbines are generally used for sites with lower head than compared with the impulse turbines. Reaction turbines must be encased to contain the water pressure, or they must be fully submerged in the water flow.

Current hydroelectric power generators use centrifugal devices like propellers and impellers in low (<30 m) and medium (30-300 m) head applications. Head is pressure created by the difference in elevation between the water intake for the turbine and the water turbine. Many propeller and impeller type turbines require high pressure head to perform efficiently, but many geographic locations do not have enough elevation change to create high pressure head.

To create head, water can be collected or diverted. So, some systems employ a pump to move water so that it can pass through the turbine. This increases the complexity by having one set of pipes and diversion mechanisms aimed at the turbine, and a second set of such equipment for the pump.

### SUMMARY

The present disclosure proposes an improved gear pump and turbine unit that is capable of moving a large volume of water in a bidirectional manner. The unit can operate efficiently in high and low head applications by leveraging attributes of both impulse and reaction turbines. And, the device is operable fully or partially submerged and can use a siphon effect to operate when not submerged at all. The device can be installed in any orientation, alleviating issues of precise alignment for power generation.

In one embodiment, a gear pump unit for hydroelectric power generation may comprise a gear pump (131). The gear pump (131) comprises a case (131B) comprising a fluid inlet (132) and an outlet (135). A first rotor (133) is in the case (131B), the first rotor comprising a first plurality of radially spaced teeth (133A, 133B, 133C), wherein the first plurality of radially spaced teeth wrap around the first rotor helically in a clockwise direction. A second rotor (134) is in the case (131B), the second rotor comprising a second plurality of radially spaced teeth (134A, 134B, 134C), wherein the second plurality of radially spaced teeth wrap around the second rotor helically in a counter-clockwise direction, and wherein the first plurality of teeth mesh with the second plurality of teeth. A shaft (136) operatively connects to the first rotor (133) and to the second rotor (134). A generator (138) operatively connects to the shaft (136). A control module 150 operatively connects to the gear pump (131) and is configured to selectively rotate the first rotor in a first direction and to selectively rotate the second rotor in a second direction. The control mechanism is further configured to selectively reverse the rotation direction of the first rotor and to selectively reverse the rotation direction of the second rotor.

A method of operating a hydroelectric power gear pump unit (130) comprises the step of supplying a fluid to an inlet (132) of a gear pump (131) case (131B). Fluid moves through through a chamber (131A) of the case (131B) by rotating a first rotor (133) in the case (131B), the first rotor comprising a first plurality of radially spaced teeth (133A, 133B, 133C). Fluid moves through the chamber (131A) of the case (131B) by simultaneously rotating a second rotor (134) in the case (131B), the second rotor comprising a second plurality of radially spaced teeth (134A, 134B, 134C). Fluid is expelled through an outlet (135) of the gear pump case (131B). Electricity is generated by coupling the rotational energy of the first rotor and the rotational energy of the second rotor to a generator (138). Pumping is performed by reversing the rotating of the first rotor and the second rotor to move the fluid from the outlet (135) to the inlet (132).

It is to be understood that both the foregoing general description and the following detailed description are exemplary and explanatory only and are not restrictive of the claims.

### BRIEF DESCRIPTION OF THE DRAWINGS

The accompanying drawings, which are incorporated in and constitute a part of this specification, illustrate principles of the disclosure.

FIG. 1A is a schematic of a high head hydroelectric power generation system.

FIG. 1B is an alternative schematic of a high head hydroelectric power generation system.

FIG. 2 is a schematic view of a gear pump unit.

FIG. 3 is a schematic of a TVS type supercharger gear pump unit.

FIG. 4 is a schematic of a low head application

### DETAILED DESCRIPTION

Reference will now be made in detail to the present exemplary embodiments, examples of which are illustrated in the accompanying drawings. Wherever possible, the same reference numbers will be used throughout the drawings to refer to the same or like parts. In this specification, upstream and downstream are relative terms that explain a relationship between parts in a fluid flow environment. Water, when flowing according to natural forces, moves from a first upstream location to a second downstream location. When mechanical means intervene, the flow direction can be altered, so the terms upstream and downstream assist with explaining the natural starting point (upstream) with respect to a location water would naturally move to (downstream).

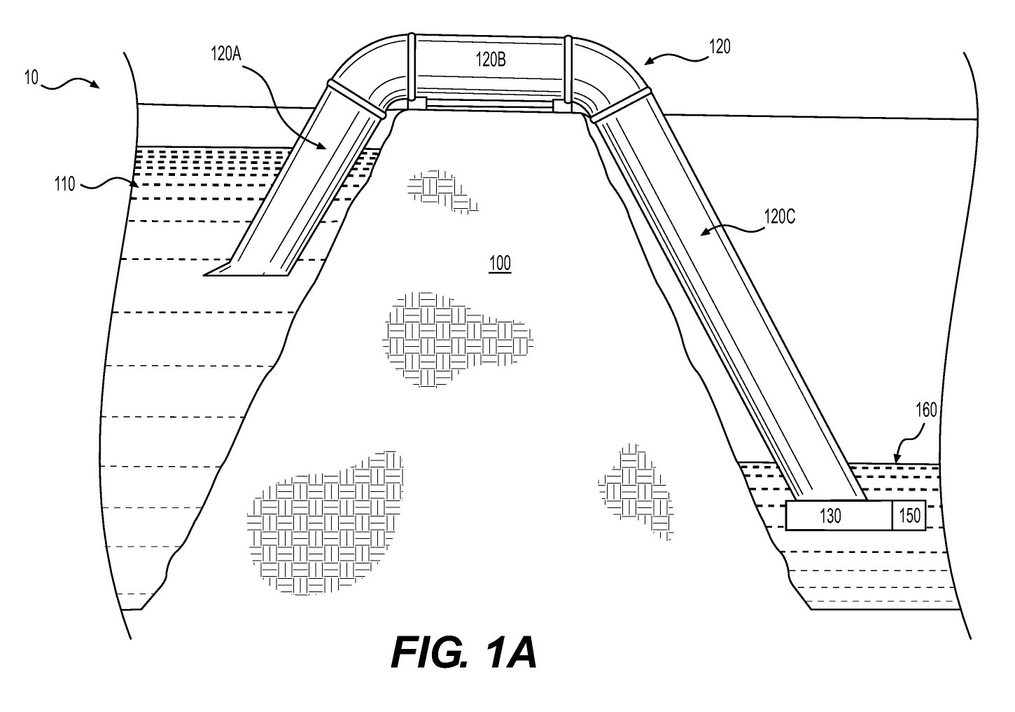

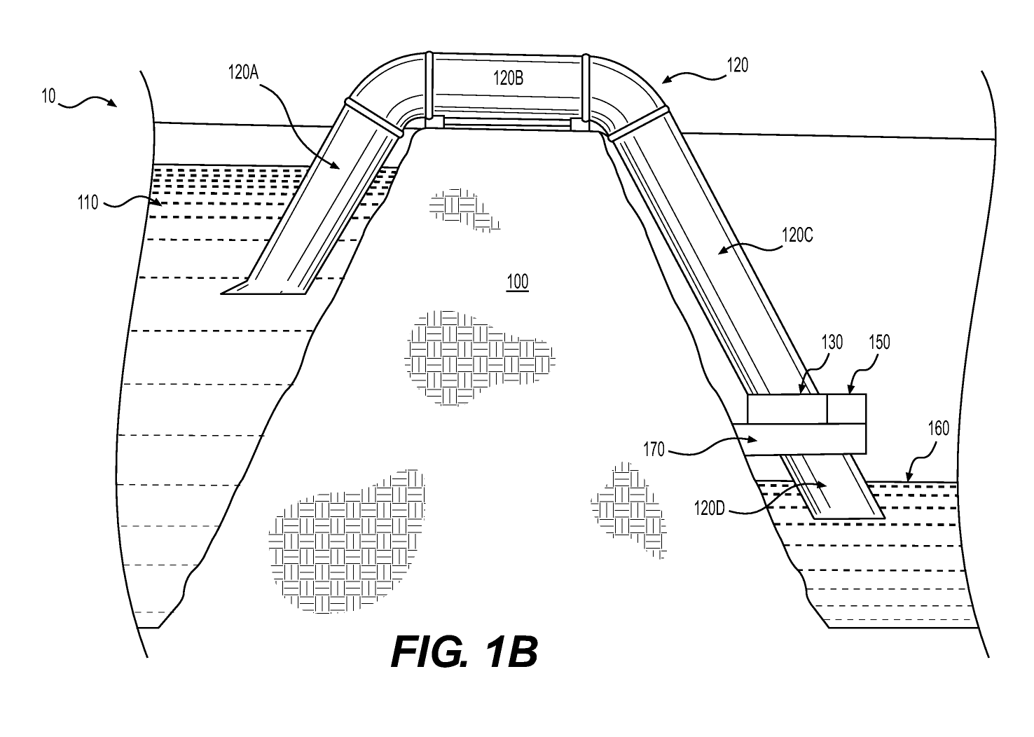

FIG. 1A shows a schematic view of hydroelectric power generation system 10. In this example, system 10 is a high head system with a dam 100 forming a reservoir 110 of water. System 10 comprises a penstock 120 and a gear pump unit 130. The penstock 120 may be a tube like structure that extends from upstream of the gear pump unit 130 to the gear pump unit 130. The penstock 120 is a conduit for water. The penstock 120 may be divided into three main parts. A first leg 120A of the penstock 120 is placed in reservoir 110. Reservoir 110 is located in an upstream portion of a river 160. Top, or second, part 120B of the penstock 120 is located on the top of a dam 100. The third leg 120C of the penstock 120 is located on a downstream side of reservoir 110. The leg 120C is extended to an inlet port 132 of the gear pump unit 130 to supply water. The gear pump unit 130 is connected to the penstock 120 to pump water upstream to return water to the reservoir 110. Further, the gear pump unit 130 may operate in a turbine mode to generate hydroelectricity using the water coming through the penstock 120 from the reservoir 110 to the river 160. The gear pump 130 may be submerged in water as shown, or may not be submerged fully. As shown in FIG. 1B, a platform 170 supports the gear pump unit 130 above the river 160 and a tailrace, or fourth leg 120D, extends out of gear pump unit 130 in to river 160. The fourth leg 120D can be alternatively included on the submerged embodiment of FIG. 1A.

The gear pump unit 130 is scalable for pumping air, water, or mixtures of air and water. The gear pump unit 130 is a positive displacement pump modeled on a Roots supercharger. Compared to an automotive supercharger, the inlet and outlet ports are adjusted for providing fluid flow with minimal or no compression. The rotor angles are also adjusted for accommodating the velocity of the water, which is based on the available head. Because the positive displacement pump can be optimized for fluid flow, it can move water, air, or a mixture or water and air. It does not need a pure water stream to operate in turbine or pump modes.

The gear pump unit 130 is bidirectional, meaning it can receive water from the reservoir 110 and expel it to a stream 160. The gear pump unit 130 can also siphon from the stream 160 and pump fluid back to the reservoir 110. The gear pump unit 130 can also operate in turbine mode to generate electricity.

When operating in a forward pump mode, the gear pump unit 130 draws up water from the reservoir 110 through leg 120A of penstock 120, and then supplies the same to the leg 120C of penstock. More specifically, once the gear pump unit 130 is activated, it may suck water up the leg 120A. The water travels through second leg 120B, which may be embedded in dam 100 or fitted or retrofitted to the top of the dam 100, as shown. The suction by gear pump unit 130 draws the water through third leg 120C. Once sufficient fluid is drawn in to third leg 120C, then the gear pump unit 130 can cease sucking water in to the penstock 120. So long as first leg 120A remains submerged in water, siphon effect will supply water from the reservoir 110 to the gear pump unit 130 through the penstock 120. Thus, gear pump unit 130 converts from forward pumping mode to turbine mode once siphon effect is established. Should the need arise, gear pump unit 130 can operate in pump mode even after siphon effect is established, for purposes such as pumping down reservoir 110.

By employing a control module 150, the gear pump unit 130 can receive electronic commands to operate in forward, reverse, or turbine modes. Inclusion of sensors in the control module 150 enables feedback control.

Although the placement of penstock 120 in FIG. 1A is shown to be around the dam 100 and in open air, it is not be restricted as such. The penstock 120 can also be placed below the water level, fully submerged. Thus the gear pump unit 130 and penstock may be installed in the original dam 100 infrastructure, or it may be retrofitted, or it may be installed directly in a river. It may replace original installation, or supplement its capacity.

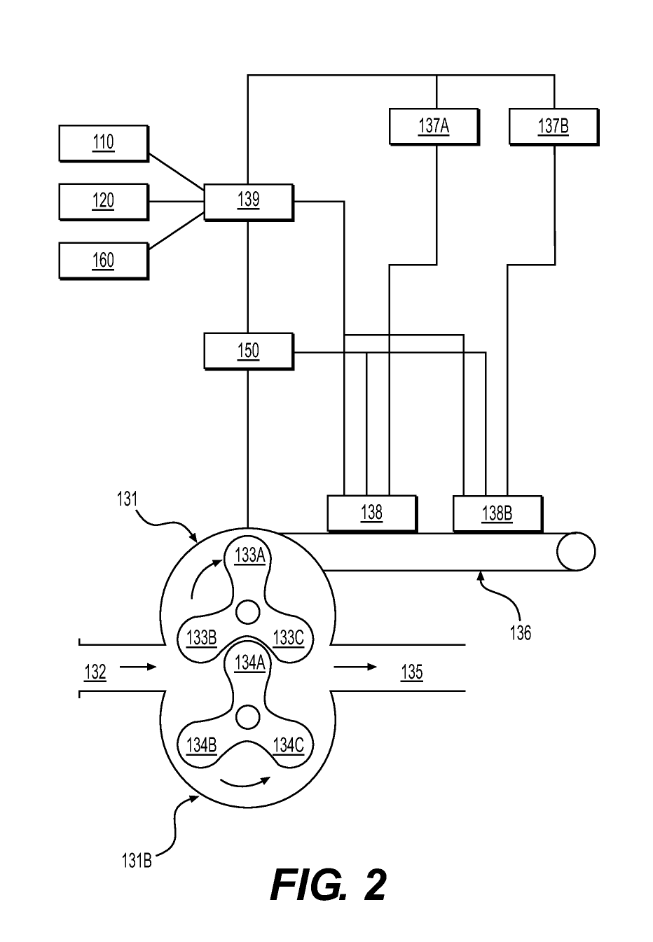

FIG. 2 shows the gear pump unit 130 in more detail. The gear pump unit 130 comprises a gear pump 131 and a generator 138. The gear pump 131 comprises an inlet 132, rotors 133 and 134, a chamber 131A, and an outlet 135. The gear pump unit 130 may be submerged in the water. In addition, the gear pump unit 130 may be positioned partly out of the water. The gear pump 131 is able to avoid cavitation effects by appropriate design of the rotors in the housing. To pump out air and supply water through the gear pump unit 131, the inlet 132 and the outlet 135 have ports that allow either water or air to travel through the gear pump 131. The inlet 132 can comprise connectivity to portions of penstock 120. And, the outlet 135 can comprise connectivity to a tailrace or fourth leg 120D of penstock to submerge the expulsion point of spent water and to provide access to water during pump mode. A pool can be provided near the outlet of the fourth leg 120D to facilitate the submersion.

Gear pump 131 is a positive displacement pump such as a Roots-type supercharger. Preferably, an Eaton Corporation TWIN VORTICES SERIES TVS helical rotor supercharger. As fluid enters through inlet 132, rotors 133 and 134 within the chamber 131A trap the fluid, air or water, between teeth of the rotors and the case 131B. Case 131B encases rotors 133 and 134. As the rotors spin, fluid is expelled out outlet 135.

Rotors 133, 134 may be identical in shape. Each rotor 133, 134 may have multiple teeth 133A, 133B, 133C, 134A, 134B, 134C. For instance, each rotor in FIG. 2 has three teeth, though other numbers, such as two or four teeth per rotor, can be used.

By comparison, in conventional gear motors and pumps, there are 15-25 teeth. These conventional gears are 1-3 inches in diameter. Since the gears have a relatively small diameter and high tooth count, the amount of water volume moved is small. As a result, the power generated is be limited. In contrast, each rotor of the gear pump 131 has 3-4 teeth having a very large diameter of up to 40 inches. Due to the larger diameter, the gear pump 131 of the present invention pumps a larger volume of water per tooth. In a large hydroelectric application, gear pump unit 131 could comprise a low number of teeth with a 25-40 inch diameter gear. The teeth would have a low diametral pitch and would pump a large volume of water per tooth. The lower number of teeth and larger volume increases the displacement efficiency of the device. The sizes given are exemplary only, with size scaling for application.

Also by comparison, conventionally, there are approximately 15-25 teeth on a gear motor or turbine. These teeth are 1-3 inches in diameter. Since the teeth have a relatively small diameter, the amount of water volume displaced is small. As a result, the power generated is limited. In contrast, each rotor of the gear pump 131 has 3-4 teeth having a diameter of 3-6 inches. Due to the larger diameter, the gear pump 131 of the present invention pumps a larger volume of water per tooth. In a large hydroelectric application, gear pump unit 131 could comprise a low number of teeth with a 25-40 inch diameter per tooth. The teeth would have a low diametral pitch and would pump a large volume of water per tooth. The lower number of teeth and larger volume increases the energy efficiency of the hydroelectric power generation. It also increases the speed of rotation of the turbine, which reduces the cost of directly coupled generators.

To further reduce cost of materials, the teeth can be made hollow. To help improve efficiency the teeth can be cladded with a corrosion and wear resistant metallic powder, such as Eaton Corporation's EATONITE. Other materials, including low friction materials, improve aslo the efficiency. Thus, the rotors and or teeth can be coated with materials including IN718, IN625, Cobalt Chrome, Stainless Steel, Titanium alloys, Nickel based super alloys and coatings, ultra high strength steels, and metal matrix nano composites. Thus, the gear pump 131 can be manufactured using laser welding, laser-assisted additive manufacturing, laser surface treatment and processing, additive manufacturing (AM) techniques, and near net shape (NNS) techniques.

Volume displacement devices such as gear pumps 131 have much better air/water handling characteristics than traditional turbines. Unlike an Archimedes Screw, an axial turbine system, or a centrifugal system, the gear pump 131 of this disclosure has dual rotors and a helical structure to the rotor. This brings improved efficiency at low or high head applications. In addition, unlike an Archimedes Screw, the twin vortices (TVS) supercharger is housed, allowing it to leverage both impulse turbine characteristics, as by the velocity of water turning the rotors, and reaction turbine characteristics, as by the pressure build in the encasement. The gear pump 131 is also designed to pump bi-directionally, which is not possible with Archimedes screw or prior art impulse or reaction turbines. The TVS is also unaffected by orientation, location, cavitation, tail water, and tail size.

FIG. 2 shows the rotor 133 having three teeth, 133A, 133B, and 133C. Similarly, the rotor 134 has three teeth, 134A, 134B, and 135C. Other numbers of teeth are possible. For example, the rotors can have between 2 and 5 teeth each. To facilitate rotor mesh, the rotors 133 and 134 should have an identical number of teeth. Rotors 133, 134 can be helical. The teeth can twist over the length of the rotors so that the respective teeth wrap around their respective rotor. As an example, the teeth can twist 120 degrees over the length of the rotor, or the teeth can twist 60 degrees over the length of the rotor. The degree of twist varies based on the head of the application. The degree of twist is also a function of the number of teeth, the outside diameter of the rotor, and the center distance of the rotors. Ideally, the teeth will be optimized to have the largest possible twist for the given application.

In addition, each tooth has a diametral pitch, or angle that the tooth projects from its rotor. Compared to an automotive supercharger, a gear pump for a water application has lower diametral pitch. The teeth mesh as the rotors rotate. For example, teeth 133A, 133B, 133C of rotor 133 are twisted clockwise while the teeth 134A, 134B, 134C of rotor 134 are twisted counter-clockwise. Rotors 133, 134 are meshed together and geared to rotate in opposite directions. Rotors 133, 134 rotate in response to commands from control module 150 for turbine mode or pump mode.

The velocity of the water entering the gear pump 131 is a function of the pressure of the water, which is related to the head of the source. The speed at which the device will rotate is a function of the length of the rotor, twist of the teeth, and the pressure of the available fluid. For a given pressure, the smaller the length of the rotor, the faster the rotor will spin. Ideally, the design of the rotor is set up for maximum rotations per minute (RPMs) at a free flow condition. However, because ideal conditions may not be the predominant conditions, the rotor can also be designed for optimizing fluid flow during the most common conditions. When the rotor is optimized, all the pressure in the water is converted into velocity which is then turned into rotational velocity of the rotors.

The size of the gear pump will be related to the amount of fluid flow available. The length of rotors 133, 134 varies from application to application, based on the head of the water supply. The size of the gear pump 131 is also determined by the length of rotors 133, 134.

The gear pump 131 functions as a turbine to generate electricity. This is conducted with the gear pump 131 set in a turbine mode. In this mode, the water flows from the reservoir 110 to the gear pump unit 130 via the penstock 120. The water flow entering into the inlet 132 of gear pump 131 is trapped in a gap between adjacent teeth of rotor 133, for example, between teeth 133A and 133B. The water flow is trapped in a gap between adjacent teeth of rotor 134, for example, between teeth 134A and 134B. Trapped water flow turns the gear pump 131. After turning teeth of the gear pump 131, the used up water flow is carried out of the gear pump 131 through the outlet 135. The outlet 135 may be triangular shaped to match the shape of the rotors 133, 134 for allowing easy exit.

When water flow turns rotors of the gear pump 131, a shaft 136 that is connected to the rotors via transmission gears rotates. The shaft 136 in turn rotates the generator 138, which can be by direct coupling, or indirect coupling, such as via a pulley or other torque transfer device. FIG. 2 illustrates direct rotation of the generator, since the shaft 136 is connected to the generator 138. The generator 138 is a device that converts mechanical energy into electrical energy, and generator 138 may comprise a series of magnets and wires (not shown) to induce a current in the wire to produce electricity. The electricity can be fed to a power grid 137A for consumption and to a power storage device, such as a battery 137B.

The movement of water in turbine mode has been described. However, air, or a mixture of air and water, can be moved through the gear pump 131 in a similar way. In addition, the fluid flow direction can be reversed, so that water pumps from the stream 160 to the reservoir 110.

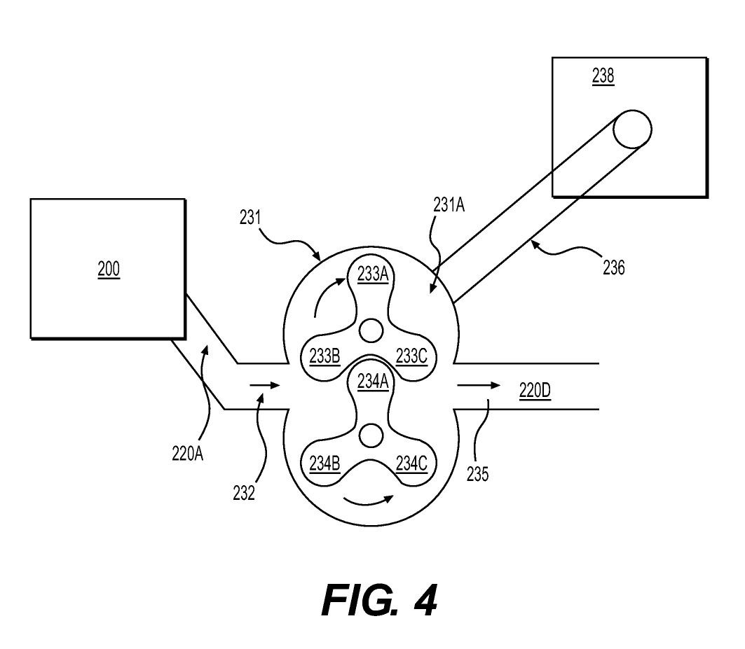

The gear pump 131 can be set in a reverse pump mode. In the reverse pump mode, the gear pump 131 functions as a pump to refill reservoir 110. A variety of control electronics, such as wiring, sensors, transmit, receive, computing, computer readable storage devices, programming, and actuator devices, can be devised to implement control mechanism 150. Programming implements modes of operation to control gear pump 131, such as to perform the pump function during off peak time and to perform the turbine mode during peak time. As one example, electricity generated during turbine mode is supplied to grid 137A during peak electricity use times. During off-peak times, electricity generated using turbine mode is stored in battery 137B. The stored electricity is returned to power an electric motor 138B affiliated via pulley hub 15 with input shaft and transmission gears of rotors 133 and 134. As the electric motor 138B turns, it also turns the gear pump 131 in a reverse direction. When the gear pump 131 is turned in a reverse direction, it moves water back up to the reservoir 110. Because the gear pump 131 can move the water back up to the reservoir 110, the necessity of having a separate pump is negated. As a result, the gear pump unit 130 is constructed with less parts than traditional hydroelectric systems and in a simplified manner. Many gating and diversion techniques are also avoided. The reverse pump mode is usable with any of FIGS. 1A, 1B, and 4. If the gear pump is not fully or partially submerged in water, at least a tailrace such as fourth leg 120D is attached to the outlet 135 or 235 and is submerged in water to enable suction of water from downstream for transfer by the gear pump to upstream.

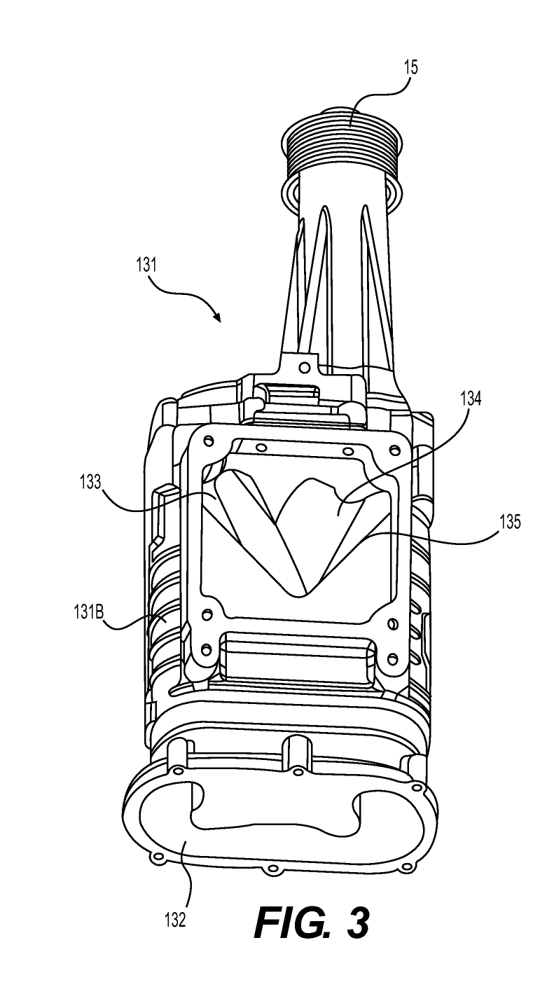

FIG. 3 illustrates one example of a TVS type supercharger manufactured by Eaton Corporation in connection with generator 138 and motor 138B. With modification, the TVS type supercharger may be used as gear pump 131. It is an axial input, radial output type having a pulley hub 15 connected to an internal shaft, transmission gears, and rotors 133 and 134. Fluid enters inlet 132 and exits outlet 135. Outlet 135 is defined by openings 21, 23 and 25 in case 131B. Details of such a supercharger may be found in U.S. Pat. No. 7,488,164, incorporated herein by reference in its entirety. While not illustrated, a radial inlet, radial output type supercharger may also be used as gear pump 131. In FIG. 3, pulleys are used to transfer rotational energy from the pulley hub 15 to generator 138, or from motor 138B to pulley hub 15.

To use the supercharger as a gear pump in pump or turbine mode, modifications should be made to facilitate maximum efficiency. These changes are angle of the rotors 133, 134 and timing of inlet 132 and outlet 135. The rotors should have a low diametral pitch to enable large volumes of water to pass through the unit. The inlet 132, outlet 135 and rotors must accommodate the incompressible nature of water and, for example, the inlet 132 and outlet 135 port sizes are adjusted and made larger. And, it is possible to adjust the port timing of the inlet 132 and outlet 135 for pump and turbine functions.

When in the pump mode, the twist angle of teeth is designed in consideration of the velocity of water. Because of the tradeoffs in pressure at the inlet or outlet during turbine or pump mode, the twist angle should be adjusted for a particular hydropower generation system in view of the frequency of use of pump or turbine mode. Despite this limitation, the operating range of the gear pump 131 is greater than traditional turbines because the design of the gear pump 131 can handle variable flow rates.

The “seal time” of the outlet should also be adjusted. The “seal time” refers to the number of degrees that a volume of water moves through a particular phase while trapped in between adjacent teeth of the rotor (herein referred to as control volume). When moving the water, there are three phases to the operation: 1) “initial seal time” is the number of degrees of rotation during which the control volume is exposed to the inlet port; 2) “transfer seal time” is the number of degree of rotation during which the transfer volume is sealed from inlet port; and 3) “outlet seal time” is the number of degrees during which the transfer volume is exposed to the outlet port. In order to conduct the pumping function, the seal time is changed to avoid compression of the water. One method to manipulate the seal time is to reduce or increase the width of the inlet port. The exact method of changing sealing time along with the appropriate seal time is determined to suit needs of a particular hydropower generation system.

The computing device 139 controls the gear pump unit 131 by commanding that the control module 150 operate the gear pump 130 in one of turbine mode, suction mode, or pump mode. The implementation of the computing device 139 may differ from one hydroelectric power generation system to the other. For instance, the computing device 139 may be operated based on strict time. In other words, by setting a peak hour and off-peak hour, the gear pump unit can strictly conduct a certain operation during the designated time.

Alternatively, the computing device 139 can operate to change the mode based on feedback it receives. In view of this, gear pump unit 130 and computing device 139 can include a network of additional electronics such as an array of additional sensors. The sensors could include, for example, electricity sensors in grid 137A and battery 137B, water level sensors in the reservoir 110, velocity sensors in penstock 120, RPM (rotations per minute) speed sensors in the gear pump 131, speed sensors in generator 138, and water level sensors in stream 160. Such sensors can electronically communicate with a computing device 139 having a processor, memory, and stored algorithms. The computing device 139 can emit control commands to the gear pump 131 to operate in passive (turbine), forward (suction), or reverse (pump) modes. The computing device 139 can be located with the gear pump 131, or remote from the gear pump with appropriate communication devices in place. Based on feedback, such as low electricity in the battery, the gear pump 131 can operate in suction mode to fill the penstock 120, and can then switch to turbine mode to charge the battery. Or, if a water level sensor in reservoir 110 indicates low water level, the gear pump 131 can operate in pump mode to move water from stream 160 to the reservoir 110.

The gear pump unit 130 can be constructed as a component of the hydropower generation system 10 as described in FIG. 1A. In addition, the gear pump unit 130 can supplement an existing hydropower generation plant by being a modular installation. In supplementing the existing hydropower generation plant, the gear pump 131 can simply replace the existing turbine to enhance the efficiency of the existing system. Alternatively, the gear pump unit 130 can be simultaneously used with the existing turbine and pump, as by being laid over the existing infrastructure.

FIG. 1B illustrates another benefit of the modular design, which enables easy servicing and maintenance. A platform 170 is installed at or near the water level of river 160. The gear pump unit 130 and control module 150 are stationed on the platform 170. The gear pump 131 is serviceable and the control module 150 is easily updated. Being externally mounted to the dam 100, it is not necessary to enter in to the dam 100 to service the penstock 120 or gear pump unit 130. The light weight of the hollow rotors further facilitates the modular design.

FIG. 4 shows another embodiment of the present invention. A gear pump unit 230 may be placed in a small stream to generate electricity. The gear pump unit 230 may be a low head hydroelectric power generator. The gear pump unit 230 may receive water from a water source 200 through an inlet 232. The water source 200 may be a canal or fast flowing river or stream. The gear pump unit 230 comprises a gear pump 231 and a generator 238. The gear pump 231 and the generator 238 may be connected to each other through a shaft 236 or by a pulley or other mechanical coupling. The gear pump unit 230 may be constructed similar to the gear pump unit 130 as described using FIG. 2, with additional modifications to accommodate the difference in fluid velocity in the low head application, such as underwater placement of penstock 220A leading to inlet 232, and inclusion of tailrace penstock 220D at outlet 235. The gear pump unit 230 may alternatively include another fluid diversion mechanism than penstock, such as a tray like structure.

The gear pump unit 230 can be completely submerged under the water level of a flowing water source, or may be partially submerged. If fluid flow is not sufficient to turn the turbine, power can be used to pump up the water source by operating in pump mode and filling a reservoir structure. Thus, in the low head application it is particularly advantageous to implement a combined generator/motor. However, when a reservoir is not necessary, and fluid flow is sufficient, gear pump unit 230 can be used without a costly structural base making it cost effective and portable.

In the preceding specification, various preferred embodiments have been described with reference to the accompanying drawings. It will, however, be evident that various other modifications and changes may be made thereto, and additional embodiments may be implemented, without departing from the broader scope of the invention as set forth in the claims that follow. The specification and drawings are accordingly to be regarded in an illustrative rather than restrictive sense.

Other embodiments will be apparent to those skilled in the art from consideration of the specification and practice of the disclosure. It is intended that the specification and examples be considered as exemplary only, with the true scope and spirit of the invention being indicated by the following claims.

19. A gear pump unit for hydroelectric power generation, comprising:
a gear pump comprising:
a case comprising a fluid inlet and an outlet;
a first rotor in the case, the first rotor comprising a first plurality of radially spaced teeth, wherein the first plurality of radially spaced teeth wrap around the first rotor helically in a clockwise direction;
a second rotor in the case, the second rotor comprising a second plurality of radially spaced teeth, wherein the second plurality of radially spaced teeth wrap around the second rotor helically in a counter-clockwise direction, and wherein the first plurality of teeth mesh with the second plurality of teeth; and
a shaft operatively connected to the first rotor and to the second rotor;
a generator operatively connected to the shaft; and
a control module operatively connected to the gear pump and configured to selectively rotate the first rotor in a first direction and to selectively rotate the second rotor in a second direction, the control mechanism further configured to selectively reverse the rotation direction of the first rotor and to selectively reverse the rotation direction of the second rotor.

20. The gear pump unit of claim 19, wherein the gear pump further comprises a pulley hub connected to a second end of the shaft, and wherein the gear pump unit further comprises a pulley connected between the pulley hub and the generator.

21. The gear pump unit of claim 19, wherein respective gaps are formed between each of the first plurality of teeth and between the second plurality of teeth, and wherein, when a fluid is supplied to the gear pump, and when the first rotor and the second rotor rotate, a fluid is displaced in each respective gap.

22. The gear pump unit of claim 19, wherein, when the control module selectively rotates the first rotor in the first direction and selectively rotates the second rotor in the second direction, and when an inlet fluid is supplied to the inlet, the fluid moves from the inlet to the outlet in respective gaps between the first plurality of radially spaced teeth and in respective gaps between the second plurality of radially spaced teeth, and wherein, when the control mechanism selectively reverses the rotation direction of the first rotor and selectively reverses the rotation direction of the second rotor, and wherein a tailrace fluid is supplied to the outlet, the tailrace fluid moves from the outlet to the inlet in the respective gaps between the first plurality of radially spaced teeth and in the respective gaps between the second plurality of radially spaced teeth.

23. The gear pump unit of claim 22, wherein the fluid is air, water, or a mixture of air and water, and wherein the fluid moves in the gear pump without cavitation.

24. The gear pump unit of claim 19, further comprising a penstock fluidly coupled to the inlet.

25. The gear pump unit of claim 24, wherein the penstock comprises:
a first leg in a reservoir;
a second leg on a dam; and
a third leg connected to the gear pump.

26. The gear pump unit of claim 25 wherein the dam comprises a platform, wherein the gear pump is mounted on the platform, and wherein the gear pump is not submerged.

27. The gear pump unit of claim 19, further comprising a computing device in communication with the control module, the computing device further comprising a network of sensors, a processor, a memory, and stored algorithms, the computing device configured to emit commands to the control module to operate the gear pump in one of a turbine mode, a suction mode, or a pump mode.

28. The gear pump unit of claim 19, wherein the first plurality of radially spaced teeth comprises a total number of teeth in the range of 2-5, and wherein the second plurality of radially spaced teeth comprises a total number of teeth in the range of 2-5.

29. The gear pump unit of claim 28, wherein each tooth of the first plurality of radially spaced teeth and each tooth of the second plurality of radially spaced teeth comprises a diameter of 25 to 50 inches.

30. The gear pump unit of claim 19, wherein the gear pump is configured to move water, air, and a mixture of water and air.

31. The gear pump unit of claim 19, wherein the gear pump is an axial-input, radial-outlet type supercharger.

32. The gear pump unit of claim 19, wherein each of the first plurality of radially spaced teeth and each of the second plurality of radially spaced teeth are hollow.

33. A method of operating a hydroelectric power gear pump unit comprising the steps of:
supplying a fluid to an inlet of a gear pump case;
moving the fluid through a chamber of the case by rotating a first rotor in the case, the first rotor comprising a first plurality of radially spaced teeth;
moving the fluid through the chamber of the case by simultaneously rotating a second rotor in the case, the second rotor comprising a second plurality of radially spaced teeth;
expelling the fluid through an outlet of the gear pump case;
generating electricity by coupling the rotational energy of the first rotor and the rotational energy of the second rotor to a generator; and
reversing the rotating of the first rotor and the second rotor to move the fluid from the outlet to the inlet.

34. The method of claim 33, wherein the step of supplying the fluid to the inlet further comprises supplying the fluid to a first leg of a penstock, and wherein the method of operating a hydroelectric power gear pump unit further comprises the step of operating the gear pump to siphon the fluid in to the first leg of the penstock.

35. The method of claim 33, wherein the step of reversing the rotating of the first rotor and the second rotor further comprises the step of operating the gear pump to siphon the fluid in to the gear pump.

36. The method of claim 33, wherein the first plurality of radially spaced teeth wrap around the first rotor helically in a clockwise direction, and wherein the second plurality of radially spaced teeth wrap around the second rotor helically in a counter-clockwise direction, and wherein the first plurality of teeth mesh with the second plurality of teeth.
